(19) United States
(12) Patent Application Publication
(10) Pub. No.: US 2010/0279020 A1
(43) Pub. Date: Nov. 4, 2010

(54) METHOD OF FORMING IN-SITU PRE-GaN DEPOSITION LAYER IN HVPE

(75) Inventors: Yuriy Melnik, Santa Clara, CA (US); Hidehiro Kojiri, Sunnyvale, CA (US); Olga Kryliouk, Sunnyvale, CA (US); Tetsuya Ishikawa, Saratoga, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/770,306

(22) Filed: Apr. 29, 2010

Related U.S. Application Data
(60) Provisional application No. 61/173,906, filed on Apr. 29, 2009.

(51) Int. Cl. B05D 1/36

(52) U.S. Cl. 427/419.7

(57) ABSTRACT

A method and apparatus is provided for preparing a substrate for forming electronic devices incorporating III/V compound semiconductors. Elemental halogen gases, hydrogen halide gases, or other halogen or halide gases, are contacted with liquid or solid group III metals to form precursors which are reacted with nitrogen sources to deposit a nitride buffer layer on the substrate. The buffer layer, which may be a transition layer, may incorporate more than one group III metal, and may be deposited with amorphous or crystalline morphology. An amorphous layer may be partially or fully recrystallized by thermal treatment. Instead of a layer, a plurality of discrete nucleation sites may be formed, whose size, density, and distribution may be controlled. The nitrogen source may include reactive nitrogen compounds as well as active nitrogen from a remote plasma source. The composition of the buffer or transition layer may also vary with depth according to a desired profile.

### CROSS-REFERENCE TO RELATED APPLICATIONS

This application claims benefit of U.S. Provisional Application Ser. No. 61/173,906, filed Apr. 29, 2009, which is incorporated herein by reference.

### FIELD

Embodiments of the invention relate to the manufacture of devices such as light emitting diodes (LEDs) or laser diodes (LDs), and more particularly to methods of forming substrates for such devices.

### BACKGROUND

Group III nitride semiconductors such as gallium nitride (GaN) are finding greater importance in the development and fabrication of a variety of semiconductor devices, such as short wavelength light emitting diodes (LEDs), laser diodes (LDs), and electronic devices including high power, high frequency, high temperature transistors and integrated circuits. One method that has been used to deposit Group-III nitrides is hydride vapor phase epitaxial (HVPE) deposition. In HVPE, a halide reacts with the Group-III metal to form a metal containing precursor (e.g., metal chloride). The metal containing precursor then reacts with a nitrogen containing gas to form the Group-III metal nitride.

As the demand for LEDs, LDs, transistors and integrated circuits increases, the efficiency of depositing the group III metal nitride takes on greater importance. There is a general need for a deposition apparatus and process with a high deposition rate that can deposit films uniformly over a large substrate or multiple substrates. Additionally, uniform precursor mixing is desirable for consistent film quality over the substrate. Therefore, there is a need in the art for an improved HVPE deposition method and an HVPE apparatus.

### SUMMARY

Embodiments of the invention provide a method of depositing a film on a substrate, comprising exposing a first group III metal to a first hydrogen-free halogen containing gas to form a first precursor, exposing a second group III metal to a second hydrogen-free halogen containing gas to form a second precursor, forming a first film on the substrate by reacting the first precursor with a first nitrogen source in a process chamber, and forming a second film on the substrate by reacting the second precursor with a second nitrogen source in the process chamber.

Other embodiments provide a method of forming a support surface for electronic devices, comprising forming a foundation surface comprising a nitrogen containing film on a structural substrate by exposing the structural substrate to a nitrogen containing gas, contacting a first hydrogen-free halogen containing gas with a first metal to form a first precursor, depositing a buffer layer adjacent to the foundation surface by reacting the first precursor with a first reagent, contacting a second hydrogen-free halogen containing gas with a second metal to form a second precursor, and depositing a layer adjacent to the buffer layer by reacting the second precursor with a second reagent to form the support surface.

Other embodiments provide a method of treating a substrate, comprising exposing a first metal to a first hydrogen-free halogen containing gas to form a first halide precursor, exposing a second metal to a second hydrogen-free halogen containing gas to form a second halide precursor, and reacting the first and second halide precursors with a nitrogen source in a volumetric ratio selected to deposit a first layer comprising desired amounts of the first and second metals on the substrate.

Other embodiments provide a method of depositing a film on a substrate, comprising flowing a first hydrogen-free halogen containing gas across a first metal to form a first metal halide precursor, flowing a second hydrogen-free halogen containing gas across a second metal to form a second metal halide precursor, reacting the first metal halide precursor with a first nitrogen source to deposit a plurality of discrete nucleation sites on the substrate, each nucleation site comprising the first metal, and reacting the second metal halide precursor with a second nitrogen source to deposit a film comprising the second metal on the substrate.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of an exemplary LED device.

FIG. 2 is a flow diagram summarizing a method according to one embodiment.

FIG. 3 is a flow diagram summarizing a method according to another embodiment.

FIG. 4 is a schematic cross-sectional view of an apparatus according to another embodiment.

FIG. 5 is a schematic cross-sectional view of an apparatus according to another embodiment.

FIG. 6 is a plan view of an apparatus according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein generally provide methods and apparatus for forming support substrates for electronic devices comprising compound semiconductors of the “III/V” variety. Group III metal nitride materials may provide a support layer for III/V devices on a structural substrate. Some embodiments may be used to provide support substrates for LEDs, laser diodes, and other devices based on gallium nitride, indium nitride, and aluminum nitride. In a typical device, a p-n junction is formed on a structural substrate, which may also serve as an electrical contact for injecting current. Current injected into the junction causes electrons to combine with holes, releasing light for materials having direct bandgaps. The structural substrate may be any suitable substrate, such as a single crystal substrate, upon which an N-doped group III nitride epitaxial film may be formed. Structural substrates that may be used for embodiments of the invention include, but are not limited to, silicon (Si), silicon carbide (SiC), sapphire or other forms of aluminum oxide (Al₂O₃), lithium aluminum oxide (LiAlO₂), lithium gallium oxide LiGaO₂), zinc oxide (ZnO), gallium nitride (GaN), aluminum nitride (AlN), quartz, glass, gallium arsenide (GaAs), spinel (MgAl₂O₄), any combination thereof, any mixture thereof, or any alloy thereof. In some embodiments, any well known method, such as masking and etching may be utilized to form features on a planar substrate to create a patterned substrate. In a specific embodiment, the patterned substrate is a (0001) patterned sapphire substrate (PSS). Patterned sapphire substrates may be ideal for use in the manufacturing of LEDs because they increase the light extraction efficiency which is extremely useful in the fabrication of a new generation of solid state lighting devices.

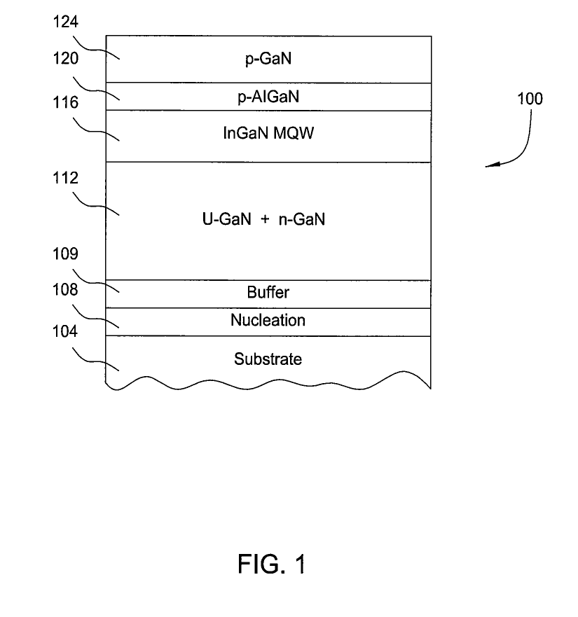

FIG. 1 is a side view of an exemplary GaN-based LED structure 100. It is fabricated over a substrate 104. Substrate size may range from 50 mm-100 mm in diameter or larger. An undoped gallium nitride (u-GaN layer) followed by an n-type GaN layer 112 is deposited over a GaN or aluminum nitride (AlN) buffer layer 108 formed over the substrate. An active region of the device is embodied in a multi-quantum-well (MQW) layer 116, shown in the drawing to comprise an InGaN layer. A p-n junction is formed with an overlying p-type AlGaN layer 120, with a p-type GaN layer 124 acting as a contact layer.

In most devices of this kind, a group III nitride film is formed on a structural substrate. The group III nitride film generally serves as a support layer for the p-n junction formed thereon. To facilitate forming such a film, a buffer or transition layer is usually formed on the substrate prior to the group III nitride film. The buffer or transition layer facilitates the transition of crystallographic and thermal properties between the substrate and the support layer, reducing the tendency of layers to delaminate. A first doped group III nitride layer, formed with an n-type or p-type dopant, is formed over the buffer or transition layer. A multi-quantum-well layer is formed over the first doped group III nitride layer, and a second doped group III nitride layer is formed over the active layer, with opposite dopant type from the first doped group III nitride layer, to form a p-n junction that can be used to convert electrical energy into radiation.

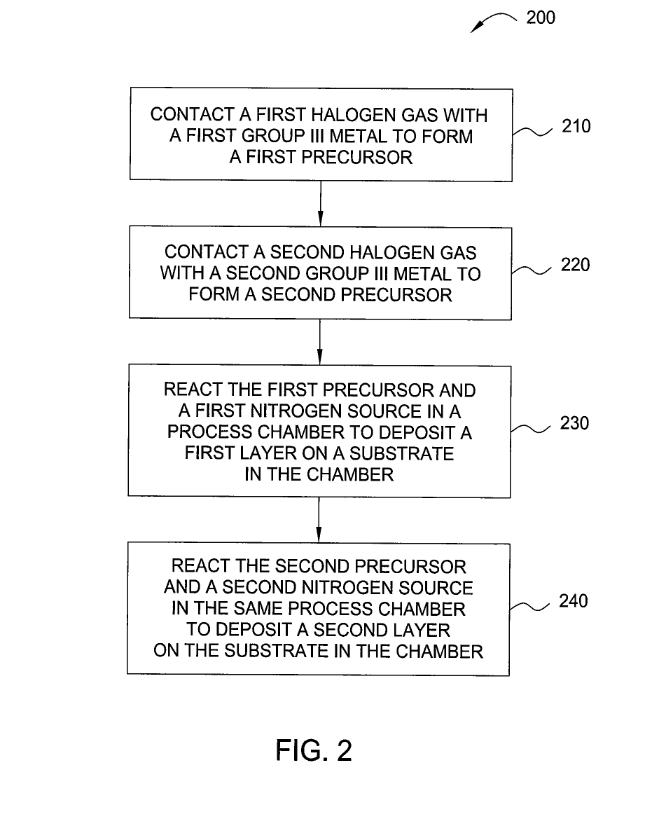

FIG. 2 is a flow diagram summarizing a method 200 according to one embodiment. The method of FIG. 1 may be used to form a support surface on a substrate for a compound semiconductor device such as that described above in connection with FIG. 1. At 210, a first halogen containing gas is contacted with a first group III metal to form a first precursor. The halogen containing gas may be a halide gas, and/or may be hydrogen-free. In some embodiments, the halogen containing gas may comprise fluorine gas (F₂), chlorine gas (Cl₂), bromine gas (Br₂), iodine gas (I₂), hydrogen fluoride gas (HF), hydrogen chloride gas (HCl), hydrogen bromide gas (HBr), hydrogen iodide gas (HI), or mixtures and combinations thereof. The group III metals may be gallium, aluminum, indium, or a mixture, combination, or alloy thereof. The halogen containing gas flows across a reservoir containing the group III metal, which may be liquid or solid. The gas reacts with the metal to form a metal halide gas, which is used as a reaction precursor in forming the film.

At 220, a second halogen containing gas is contacted with a second group III metal to form a second precursor. In one exemplary embodiment, a first reservoir contains solid aluminum, while a second reservoir contains liquid gallium. The reservoirs are heated to maintain the gallium in a liquid state, and to encourage the halogenation reaction. Chlorine gas flows over both metals simultaneously or sequentially, and the resulting halides are used to deposit a film on the substrate.

In one embodiment of method 200, prior to performing the process at step 210, 220, or 230a sapphire substrate is disposed in a process chamber and heated to a temperature between about 500° C. and about 1,100° C., such as between about 850° C. and about 1,100° C., at a temperature ramp rate between about 1° C./sec and about 5° C./sec. The substrate is thermally cleaned and nitrided by flowing ammonia and nitrogen gas at a rate between about 100 sccm and about 15,000 sccm for 5-20 minutes. Nitriding the substrate provides a thin foundation layer for depositing the support layer for electronic devices. In one embodiment, the thermal cleaning may be performed by flowing a cleaning gas mixture into the processing chamber while heating the one or more substrates to a cleaning temperature. In one embodiment, the cleaning gas mixture comprises ammonia, a halogen containing gas (e.g., Cl₂, F₂, Br₂, I₂) and a carrier gas. In one embodiment, the carrier gas may comprise nitrogen gas (N₂).

At 230, the first precursor is reacted with a first nitrogen source in a process chamber to deposit a first layer on the substrate. The first layer may serve as a buffer layer between the substrate and the second layer described below. In one embodiment, the first nitrogen source is ammonia. In other embodiments, the first nitrogen source may be one or more active nitrogen species derived from a remote plasma of a nitrogen containing material such as nitrogen gas (N₂), nitrous oxide (N₂O), ammonia (NH₃), hydrazine (N₂H₄), diimide (N₂H₂), hydrazoic acid (HN₃), and the like. In other embodiments, the first nitrogen source may also be a mixture of ammonia and one or more active nitrogen species. The first nitrogen source may also be delivered with a diluent or carrier gas, which may be at least partially reactive, such as nitrogen gas, or non-reactive, such as helium or argon gas. The first nitrogen source reacts with the first metal halide to yield a first layer comprising a metal nitride, with hydrogen halide and potentially hydrogen gas as byproducts. The first layer will generally be up to about 300 nm thick.

At 240, the second precursor is reacted with a second nitrogen source, which may be the same as, or different from, the first nitrogen source, in the same process chamber to deposit a second layer on the substrate. The second layer comprises a metal halide, and may be substantially the same composition as the first layer, or a different composition. In one exemplary embodiment, the first layer is an aluminum nitride layer, while the second layer is a gallium nitride layer. When a target thickness for the first layer is reached, flow of the first precursor into the process chamber is stopped, and flow of the second precursor is started. The process chamber may alternately be purged with a purge gas such as nitrogen, helium, or argon, between stopping flow of the first precursor and starting flow of the second precursor. In one embodiment, it is desirable to substantially deposit an aluminum nitride film over a surface of a substrate that comprises a silicon containing material (e.g., Si, SiC) prior to form a second metal nitride layer thereon to prevent the attack, or etching, of the silicon containing surface by a gallium chloride (e.g., GaCl, GaCl₃) containing precursor gas.

An aluminum nitride buffer layer may be grown adjacent to the foundation layer by flowing chlorine gas over solid aluminum at a flowrate between about 70 sccm and about 140 sccm, with the aluminum maintained at a temperature between about 450° C. and about 650° C., to form an aluminum chloride precursor. The temperature of the substrate is ramped down to a second temperature between about 500° C. and about 950° C., such as between about 550° C. and about 700° C., for example about 640° C., at a ramp rate between about 1° C./sec and about 5° C./sec while the nitrogen source gas continues flowing at a rate between about 1,000 sccm and about 9,000 sccm, depending on reactor size. The temperature ramp rate used throughout this embodiment is useful in preventing thermal stresses from weakening adhesion of layers due to differences in thermal expansion coefficients between materials. When the substrate temperature reaches the second temperature target, the aluminum chloride precursor flow is started into the process chamber. These conditions are maintained until the aluminum nitride layer reaches a target thickness. The chlorine gas flow over the solid aluminum is then stopped.

A gallium nitride layer is then formed adjacent to the aluminum nitride layer by ramping the substrate temperature to a third target between about 550° C. and about 1,100° C., such as 900° C. and about 1,100° C., for example about 1,050° C., at a ramp rate of between about 1° C./sec and about 5° C./sec, and starting flow of chlorine gas at a flowrate between about 20 sccm and about 150 sccm across a reservoir of liquid gallium maintained at a temperature between about 700° C. and about 1,000° C. In one embodiment, the chlorine gas flow is established while the temperature is ramped. The resulting gallium chloride precursor is provided to the process chamber, and flow of the nitrogen source gas increased to a flowrate between about 6,000 sccm and about 50,000 sccm to deposit a gallium nitride layer at a rate between about 0.3 μm/hr and about 15 μm/hr. During the deposition processes, the chamber pressure is maintained between about 10 Torr and about 760 Torr, such as between about 70 Torr and about 550 Torr, for example about 450 Torr, and the chamber wall temperature is maintained at or above about 450° C.

In one embodiment, a nitrogen containing gas, such as nitrogen gas (N₂), ammonia (NH₃), or hydrazine (H₂N₂) may optionally be provided to the chamber while ramping the substrate temperature to the third target. The nitrogen containing gas used during formation of the first layer may be continued at the same flow rate during temperature ramping, or an alternate nitrogen containing gas may be provided in the same flow rate range. The nitrogen containing gas provides additional nitridation of the first layer, improving its properties as a buffer or transition layer. In another alternate embodiment, a halogen containing gas, such as a halogen or halide gas, for example chlorine gas (Cl₂) or hydrogen chloride (HCl) may be provided to the process chamber directly during formation of the first and/or second layers. Flow of the halide precursor is generally established, and then flow of the halogen or halide gas is started. The halogen or halide gas generally improves properties of the layer by providing incremental etching of poorly adhered species during formation of the layer.

In some embodiments, the first layer and the second layer may be formed in different process chambers. For example, if a gallium nitride layer is to be formed on a silicon containing substrate, such as silicon or silicon carbide, it may be advantageous to form the first layer, for example aluminum nitride, in a first chamber and the second layer, gallium nitride, in a second chamber to avoid reaction of the silicon substrate with trace quantities of gallium that may be encountered if both layers are formed in a single chamber. In general, for all methods disclosed herein that involve forming more than one layer, the forming may be performed in a single chamber or in a plurality of chambers according to the needs of individual embodiments. In some embodiments, it is desirable to couple the two or more processing chambers to a vacuum or an environmentally controlled transfer chamber so that the layer(s) deposited on the surface of the substrates will not become contaminated or oxidized during the process of transferring the substrates between the process chambers.

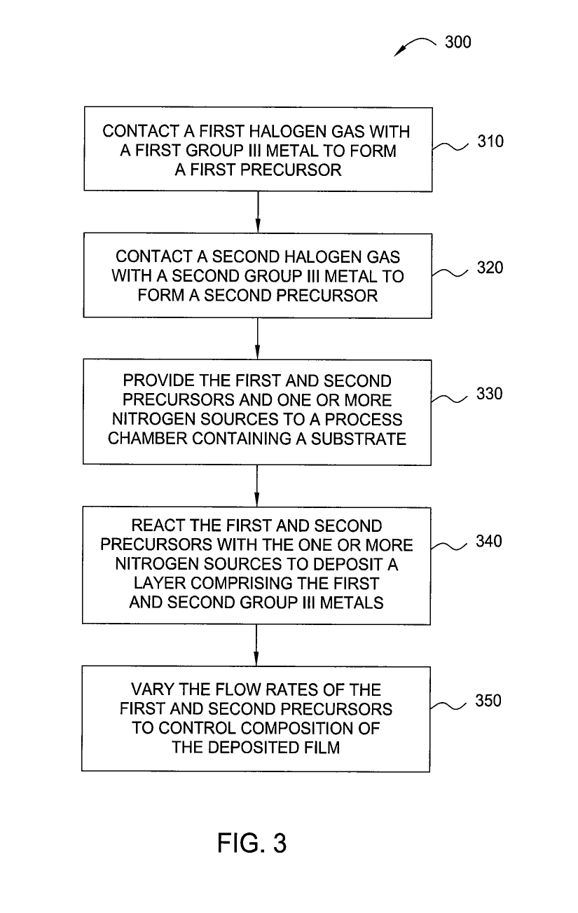

FIG. 3 is a flow diagram that summarizes a method 300 according to another embodiment. While not shown in FIG. 3, in some embodiments of the method 300, one or more substrates are thermally cleaned and nitrided using one or more of the steps discussed above prior to performing steps 310, 320 or 330. At 310, a first halogen containing gas is brought into contact with a first group III metal to form a first precursor. The halogen containing gas may be an elemental halogen gas such as fluorine, chlorine, bromine, iodine, or a mixture or combination thereof. The halogen containing gas may also be a hydrogen halide of the foregoing elements, a mixture or combination of hydrogen halides, or a mixture or combination of hydrogen halides and elemental halogen gases. The group III metal may be gallium, indium, aluminum, any combination thereof, any mixture thereof, or any alloy thereof. The group III metal may be maintained as a solid or liquid during exposure to the halogen containing gas. The halogen containing gas may be exposed to the group III metal by flowing over the metal, around the metal, or through the metal, depending on the needs of individual embodiments.

At 320, a second halogen containing gas in contacted with a second group III metal to form a second precursor. The second halogen containing gas may be the same as, or different from, the first halogen containing gas, but will generally be selected from the same group of materials. The second group III metal may likewise be the same as, or different from, the first group III metal, but will generally be selected from the same group. The second group III metal may also be solid or liquid, and may be exposed to the halogen containing gas in any of the ways mentioned above.

At 330, the first and second precursors are provided to a process chamber containing a substrate, along with a nitrogen source. The substrate is generally a structural substrate of the varieties mentioned above, and the nitrogen source may be ammonia or an active nitrogen species, as described above. The nitrogen source may be provided with a reactive carrier gas, such as nitrogen gas, or a non-reactive carrier gas, such as helium or argon.

At 340, the first and second precursors are encouraged to react with the one or more nitrogen sources to deposit a layer comprising the first and second group III metals on the substrate. The layer deposited may be a mixture of nitrides of the first and second group III metals. For example, the layer may be an aluminum indium nitride layer, or an aluminum gallium nitride layer, or an indium gallium nitride layer. In other embodiments, a third halogen containing gas may be exposed to a third group III metal, and the resulting precursor provided to the process chamber to react with the nitrogen source along with the first and second precursors to form a layer comprising three group III metals.

At 350, the flow rates of the first and second precursors are varied to control the composition of the deposited film. In one embodiment, a layer comprising aluminum and gallium may be deposited on a sapphire substrate. The layer may initially be deposited aluminum-rich to approximate the composition of the sapphire substrate, and the flowrates of the aluminum and gallium precursors may be changed steadily to increase the gallium content of the film as it thickens, ending in a gallium-rich region. Such a graded composition film may facilitate transition of properties, as described above. In one embodiment, the transition of flowrates may be linear. For example, the flowrate of the first and second precursors may start at a first target, with the first precursor in substantial excess compared to the second precursor, and may ramp to a second target, with the second precursor in substantial excess compared to the first precursor. In one embodiment, flow of the second precursor may be stopped initially to deposit an initial layer free of the second group III metal. Flow of the second precursor may then be introduced to begin deposition of a layer comprising both the first and second group III metals. Flow of the second precursor may then be ramped up while flow of the first precursor is ramped down to form a graded composition. Flow of the first precursor may then be stopped to form a final layer free of the first group III metal.

In other embodiments, transitions may be non-linear. For example, the concentration profile may be sigmoidal, or may display an abrupt shift from a first concentration to a second concentration. In some embodiments, the concentration profile may exhibit a series of step changes from a first level to a second level.

Graded compositions such as those described above may be produced by controlling the relative flowrates of the metal precursors while holding the flowrate of the nitrogen source constant. Reaction rates of the different metal precursors may likewise be influenced differently by temperature variations. Flowrates of the metal precursors may also be controlled according to a ratio of the two volumetric flow rates. For example, a ratio of the first precursor flowrate to the sum of the first and second precursor flowrates may be set initially at 90% and then ramped down to 10% at a rate determined by the thickness of the desired layer. A non-linear composition profile may also be generated by varying such a ratio in a non-linear manner.

In some embodiments, a buffer layer according to any of the compositions described above may be deposited at a temperature selected to form an amorphous crystal structure and then recrystallized to any desired degree. An amorphous film may be formed by depositing any of the nitride layers described herein at a temperature below an ordering temperature of the material being deposited. For some embodiments, depositing at a temperature below about 550° C. will result in an amorphous buffer layer. The buffer layer may then be partially or fully recrystallized by thermal treatment. In one aspect, the buffer layer may be annealed at a temperature above about 700° C., such as between about 700° C. and about 1,000° C., for example about 900° C., to accomplish recrystallization. In an embodiment wherein the buffer layer and the support layer are deposited in the same chamber, the substrate may be subjected to a heat soak step after deposition of an amorphous buffer layer and before deposition of the support layer. The heat soak step may be performed at the temperature selected for deposition of the support layer, and may have a duration between about 1 minute and about 10 minutes. Adjusting the heat soak time will affect the degree of recrystallization, with a short heat soak step resulting in small crystal domains embedded in an amorphous matrix, and a long heat soak step resulting in a substantially polycrystalline matrix with only small amorphous domains, if any.

Directional annealing may be used to recrystallize an amorphous buffer layer according to a dimensional parameter. Whereas, general baking will result in a mainly isotropic recrystallization, directional heat can be applied to recrystallize selectively near one surface or the other. For example, radiant energy may be applied to the upper surface of the deposited buffer layer to recrystallize from the surface down. Partially recrystallizing in this manner will result in a buffer layer that is substantially amorphous near the underlying substrate and substantially crystalline near the upper surface. For example, the surface of a buffer layer may be heated to a temperature of at least about 700° C. for about 1 minute. Likewise, partial recrystallization by back side heating may be expected to accomplish the reverse result. In some embodiments, directional heating to full recrystallization may be an efficient way to promote recrystallization without trapping amorphous domains in the crystalline matrix. As the material recrystallizes from one surface to the other, crystal defects and amorphous domains are less likely to remain in the matrix.

In one aspect, the buffer layer may be deposited in two or more sequences with intervening non-deposition processes between the deposition sequences. In one embodiment, a first portion of the buffer layer may be deposited at a first temperature selected to form an amorphous layer until a target thickness is reached. Deposition may then be suspended while the first portion is annealed to recrystallize at least a portion thereof. The substrate may then be thermally controlled to a second temperature selected to form a crystalline layer, and a second portion of the buffer layer deposited in a crystalline form on the first portion. In another embodiment, a deposition sequence may comprise a plurality of deposition cycles alternating with a plurality of thermal treatment, nitridation, or cleaning cycles. In any of these ways, a buffer layer may be formed that is a compound layer, and the buffer layer may be formed in the same processing chamber as the support layer formed thereafter.

In some embodiments, the nitrogen source gas may comprise active nitrogen species. The active nitrogen species may be derived by coupling a remote plasma generator to the process chamber being used to deposit the buffer layer and support layer. The remote plasma generator may be used to generate active nitrogen species such as ions and radicals comprising nitrogen by applying energy to nitrogen containing precursors. Such precursors may include nitrogen gas (N₂), ammonia (NH₃), nitrous oxide (N₂O), hydrazine (N₂H₄), diimide (N₂H₂), and hydrazoic acid (HN₃), and may be mixtures of more than one nitrogen containing compound. The energy applied is adapted to the precursor being activated, and may include energy provided from an energy source, such as a DC or RF energy, UV radiation, or microwave radiation. The nitrogen containing compounds are dissociated by the energy into ions that recombine into neutrally charged species including radicals. The activated nitrogen gas is introduced to the processing chamber by flowing through a space from the remote plasma chamber. As the gas is moving toward the processing chamber, remaining charged species are extinguished by recombination, leaving radical and other neutrally charged reactive species to react with the metal containing precursors. In some embodiments, the active nitrogen gas may be mixed with another nitrogen source or a carrier gas as described above.

As with the method of FIG. 2, a halogen containing gas may additionally be provided to the processing chamber during formation of the various films of the method 300 to improve the properties of the films. As described above, the halogen containing gas may be a halogen gas or a halide gas, such as chlorine or hydrogen chloride.

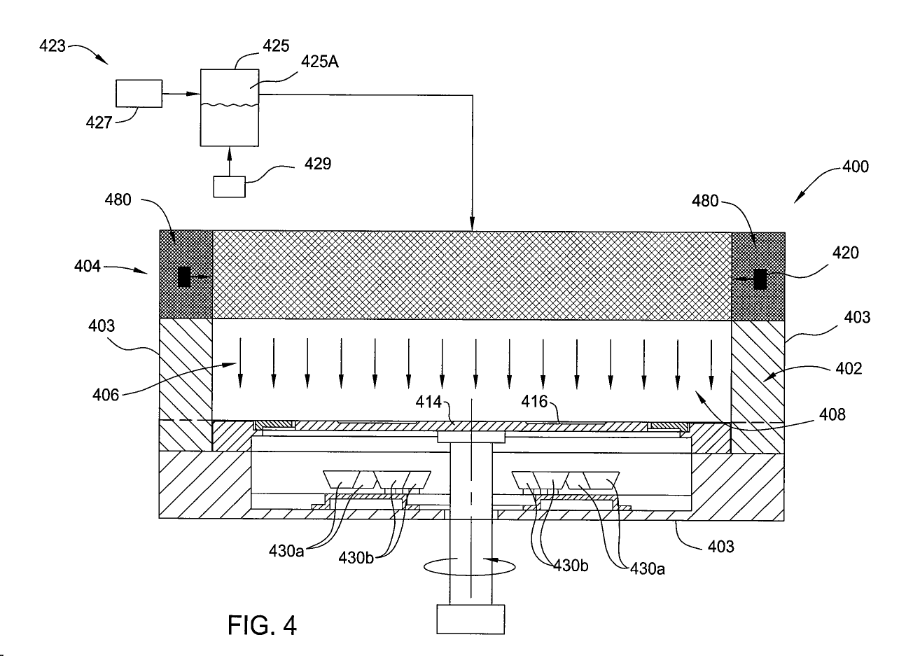

FIG. 4 is a schematic cross sectional view of an HVPE apparatus 400 that may be used to practice one or more of the embodiments of the invention described herein. The apparatus 400 in FIG. 4 includes a chamber body 402 having one or more walls 403 that encloses a processing volume 408. A showerhead assembly 404 is disposed at one boundary of the processing volume 408, and a substrate carrier 414 is disposed at another boundary of the processing volume 408. The substrate carrier 414 may include one or more recesses 416 within which one or more substrates may be disposed during processing. The substrate carrier 414 may carry six or more substrates. In one embodiment, the substrate carrier 414 carries eight substrates. It is to be understood that more or fewer substrates may be carried on the substrate carrier 414. Substrate size may range from 50 mm-100 mm in diameter or larger, while substrate carrier size may range from 200 mm-500 mm. The substrate carrier may be formed from a variety of materials, including SiC or SiC-coated graphite. It is to be understood that substrates of other sizes may be processed within the apparatus 400 and according to the processes described herein.

The substrate carrier 414 may rotate about its central axis during processing by use of a rotation motor 405. In one embodiment, the substrate carrier 414 may be rotated at a rate between about 2 RPM and about 100 RPM, such as about 30 RPM. Rotating the substrate carrier 414 aids in providing uniform exposure of the processing gases to each substrate in some embodiments. In another embodiment, the substrates may be individually rotated within the substrate carrier 414 instead of, or along with, rotating the substrate carrier 414 itself.

A plurality of lamps 430a, 430b, which may be grouped in lamp arrays, may be disposed below the substrate carrier 414. For some embodiments, a typical lamp arrangement may comprise arrays of lamps above (not shown) and below (as shown) the substrate. One embodiment may incorporate lamps from the sides. In certain embodiments, the lamps may be arranged in concentric circles. For example, the inner array of lamps 430b may include eight lamps, and the outer array of lamps 430a may include twelve lamps. In one embodiment, each of the plurality of lamps 430a, 430b is individually powered. In another embodiment, arrays of lamps 430a, 430b may be positioned above or within showerhead assembly 404. It is understood that other arrangements and other numbers of lamps are possible, according to the needs of individual embodiments. The arrays of lamps 430a, 430b may be selectively powered to heat the inner and outer areas of the substrate carrier 414. In one embodiment, the lamps 430a, 430b are collectively powered as inner and outer arrays in which the top and bottom arrays are either collectively powered or separately powered. In yet another embodiment, separate lamps or heating elements may be positioned over and/or under the source boat 480. It is to be understood that the invention is not restricted to the use of arrays of lamps. Any suitable heating source may be utilized to ensure that the proper temperature is adequately applied to the processing chamber, substrates therein, and a metal source. For example, a rapid thermal processing lamp system may be utilized.

In one embodiment, the source boat 480 may be replaced by an ampoule assembly 423 that positioned a distance from the components of the showerhead assembly 404 that are disposed on the one or more walls 403. In this configuration, halogen gas and/or an inert gas may be delivered from a gas source 427 to the well 425A of the ampoule 425, which contains a solid or liquid source material, to create a metal halide precursor (e.g., GaCl, GaCl₃, AlCl₃) that can be delivered to the processing volume 408. The ampoule may be heated by a heating source 429 to heat the source material and allow the metal halide precursor to be formed. The metal containing precursor gas may then be provided to the processing volume 408 by way of a set of gas tubes or through a conventional showerhead type assembly. A nitrogen-containing precursor gas may also be introduced into the processing volume 408 through a set of gas tubes. In some embodiments the nitrogen containing precursor gas may contain ammonia.

One or more of the plurality of lamps 430a, 430b may be powered to heat the substrates as well as the source boat 480. The lamps may heat the substrate to a temperature between about 900° C. and about 1200° C. In another embodiment, the lamps 430a, 430b maintain the metal source in well 420 within the source boat 480 at a temperature between about 350° C. and about 900° C. A thermocouple (not shown) may be positioned within the well 420 to measure the metal source temperature during processing. The temperature measured by the thermocouple may be fed back to a controller that adjusts the heat provided from the heating lamps 430a, 430b so that the temperature of the metal source in well 420 may be controlled or adjusted as necessary.

During the process according to one embodiment of the invention, precursor gases 406 flow from the showerhead assembly 404 towards the substrate surface. Reaction of the precursor gases 406 at or near the substrate surface may deposit various metal nitride layers upon the substrate, including GaN, AlN, and InN. Multiple metals may also be utilized for the deposition of “combination films” such as AlGaN and/or InGaN.

The multi-quantum well layers of a device such as the device of FIG. 1 may be formed using an MOCVD process performed on an MOCVD chamber such as that available from the Lighting Products division of Applied Materials, Inc., of Santa Clara, Calif. A substrate, such as any of the structural substrate described above, which may be prepared according to any of the methods described above, is provided to an MOCVD chamber. A group III metal organic precursor is provided to the chamber with a group V precursor and a carrier gas. Suitable group III metal organics include trimethyl gallium (TMG), trimethyl aluminum (TMA), and trimethyl indium (TMI), and combinations or mixtures thereof. Suitable group V precursors generally contain nitrogen. Reactive nitrogen containing gases that may be used to form metal nitrides include ammonia (NH₃) and hydrazine (N₂H₄). Suitable carrier gases include hydrogen (H₂), nitrogen (N₂), helium (He), argon (Ar), xenon (Xe), and combinations or mixtures thereof. In another embodiment, the nitrogen source may be one or more active nitrogen species derived from a remote plasma of a nitrogen-containing material such as nitrogen gas (N₂), nitrous oxide (N₂O), ammonia (NH₃), hydrazine (N₂H₄), diimide (N₂H₂), hydrazoic acid (HN₃), and the like. A dopant precursor may also be provided to the chamber to include dopants in the deposited film. In one embodiment, magnesium (Mg) may be added to the film as a dopant by including dicyclopentadienyl magnesium (Cp₂Mg) in the gas mixture provided to the chamber. Table 1 below provides exemplary processing conditions and precursor flow rates that are generally suitable in the growth of nitride semiconductor structures using the devices described above:

TABLE 1

| Parameter | Value |
|---|---|
| Temperature (° C.) | 500-1200 |
| Pressure (Torr) | 5-760 |
| TMG flow (sccm) | 0-50 |
| TMA flow (sccm) | 0-50 |
| TMI flow (sccm) | 0-50 |
| PH₃ flow (sccm) | 0-1000 |
| AsH₃ flow (sccm) | 0-1000 |
| NH₃ flow (sccm) | 100-100,000 |
| N₂ flow (sccm) | 0-100,000 |
| H₂ flow (sccm) | 0-100,000 |
| Cp₂Mg | 0-2,000 |

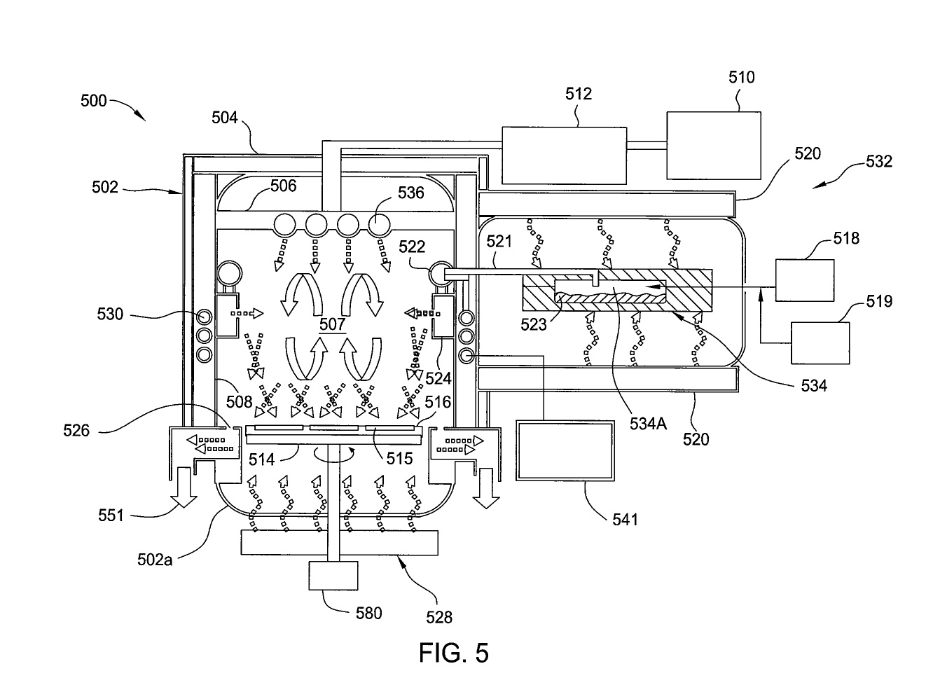

FIG. 5 is a schematic sectional view of an HVPE apparatus 500 which can be used to practice methods described herein. The HVPE apparatus 500 includes a chamber 502 enclosed by a lid 504. The chamber 502 and the lid 504 define a processing volume 507. A showerhead 506 is disposed in an upper region of the processing volume 507. A susceptor 514 is disposed opposing the showerhead 506 in the processing volume 507. The susceptor 514 is configured to support a plurality of substrates 515 thereon during processing. In one embodiment, the plurality of substrates 515 are disposed on a substrate carrier 516 which is supported by the susceptor 514. The susceptor 514 may be rotated by a motor 580, and may be formed from a variety of materials, including SiC or SiC-coated graphite.

In one embodiment, the HVPE apparatus 500 comprises a heating assembly 528 configured to heat the substrates 515 on the susceptor 514. In one embodiment, chamber bottom 502a is formed from quartz and the heating assembly 528 is a lamp assembly disposed under the chamber bottom 502a to heat the substrates 515 through the quartz chamber bottom 502a. In one embodiment, the heating assembly 528 comprises an array of lamps that are distributed to provide a uniform temperature distribution across the substrates, substrate carrier, and/or susceptor.

The HVPE apparatus 500 further comprises a precursor supplying pipes 522, 524 disposed inside the side wall 508 of the chamber 502. The pipes 522 and 524 are in fluid communication with the processing volume 507 and an inlet tube 521 found in a precursor source module 532. The showerhead 506 is in fluid communication with the processing volume 507 and a gas source 510. The processing volume 507 is in fluid communication with an exhaust 551.

The HVPE apparatus 500 further comprises a heater 530 embedded within the walls 508 of the chamber 502. The heater elements 530 embedded in the walls 508 may provide additional heat if needed during the deposition process. A thermocouple may be used to measure the temperature inside the processing chamber. Output from the thermocouple may be fed back to a controller 541 that controls the temperature of the walls of the chamber 502 by adjusting the power delivered to the heater elements 530 (e.g., resistive heating elements) based upon the reading from a thermocouple (not shown). For example, if the chamber is too cool, the heater 530 will be turned on. If the chamber is too hot, the heater 530 will be turned off. Additionally, the amount of heat provided from the heater 530 may be controlled so that the amount of heat is provided from the heater 530 is minimized.

Processing gas from the gas source 510 is delivered to the chamber volume 507 through a gas plenum 536 disposed in the gas distribution showerhead 506. In one embodiment, the gas source 510 may comprise a nitrogen containing compound. In one embodiment, the gas source 510 is configured to deliver a gas that comprises ammonia or nitrogen. In one embodiment, an inert gas such as helium or diatomic nitrogen may be introduced as well either through the gas distribution showerhead 506 or through the pipe 524, disposed on the walls 508 of the chamber 502. An energy source 512 may be disposed between the gas source 510 and the gas distribution showerhead 506. In one embodiment, the energy source 512 may comprise a heater or a remote RF plasma source. The energy source 512 may provide energy to the gas delivered from the gas source 510, so that radicals or ions can be formed, so that the nitrogen in the nitrogen containing gas is more reactive.

The source module 532 comprises a halogen gas source 518 connected to a well 534A of a source boat 534 and an inert gas source 519 connected to the well 534A. A source material 523, such as aluminum, gallium or indium is disposed in the well 534A. A heating source 520 surrounds the source boat 534. An inlet tube 521 connects the well 534A to the processing volume 507 via the pipes 522, 524.

In one embodiment, during processing a halogen gas (e.g., Cl₂, Br₂, or I₂) is delivered from the halogen gas source 518 to the well 534A of the source boat 534 to create a metal halide precursor (e.g., GaCl, GaCl₃, AlCl₃). The interaction of the halogen gas and the solid or liquid source material 523 allows a metal halide precursor to be formed. The source boat 534 may be heated by the heating source 520 to heat the source material 523 and allow the metal halide precursor to be formed. The metal halide precursor is then delivered to the processing volume 507 of the HVPE apparatus 500 through an inlet tube 521. In one embodiment, an inert gas (e.g., Ar, N₂) delivered from the inert gas source 519 is used to carry, or push, the metal halide precursor formed in the well 534A through the inlet tube 521 and pipes 522 and 524 to the processing volume 507 of the HVPE apparatus 500. A nitrogen-containing precursor gas (e.g., ammonia (NH₃), N₂) may be introduced into the processing volume 507 through the showerhead 506, while the metal halide precursor is also provided to the processing volume 507, so that a metal nitride layer can be formed on the surface of the substrates 515 disposed in the processing volume 507.

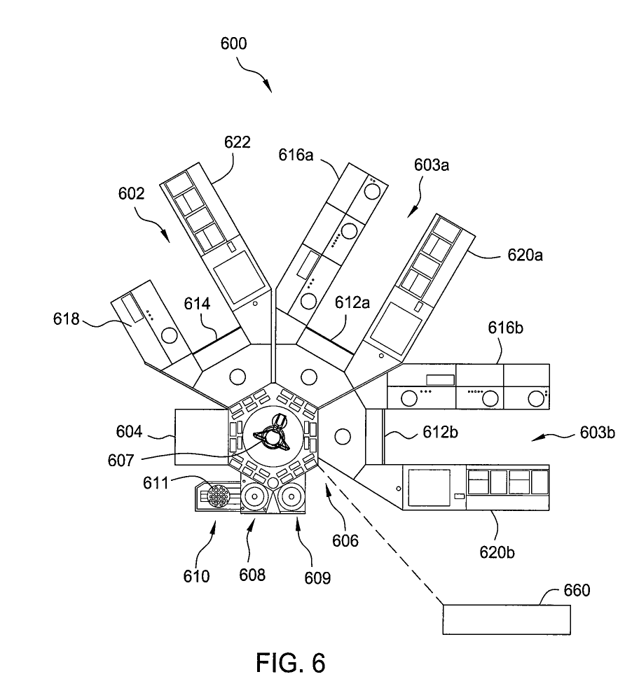

FIG. 6 is a schematic top view illustrating one embodiment of a processing system 600 comprising one HVPE chamber 602 and multiple MOCVD chambers 603a and 603b for fabricating compound nitride semiconductor devices according to embodiments described herein. In one embodiment, the environment within the processing system 600 is maintained as a vacuum environment or at a pressure below atmospheric pressure. In certain embodiments it may be desirable to backfill the processing system 600 with an inert gas such as nitrogen. Although one HVPE chamber 602 and two MOCVD chambers 603a and 603b are shown, it should be understood that any combination of one or more MOCVD chambers with one or more HVPE chambers may also be coupled with the transfer chamber 606. For example, in one embodiment, the processing system 600 may comprise 3 MOCVD chambers. In another embodiment, the processes described herein may be performed in a single MOCVD chamber. It should also be understood that although a cluster tool is shown, the embodiments described herein may be performed using linear track systems.

In one embodiment, an additional chamber 604 is coupled with the transfer chamber 606. In one embodiment, the additional chamber 604 comprises an additional processing chamber such as an MOCVD chamber or an HVPE chamber. In another embodiment, the additional chamber 604 may comprise a metrology chamber. In yet another embodiment, the additional chamber 604 may contain pre-processing or post-processing chambers, such as service chambers that are adapted for degassing, orientation, cool down, pretreatment/preclean, post-anneal and the like. In one embodiment, the transfer chamber is six-sided and hexagonal in shape with six positions for process chamber mounting. In another embodiment, the transfer chamber 606 may have other shapes and have five, seven, eight, or more sides with a corresponding number of process chamber mounting positions.

The HVPE chamber 602 is adapted to perform HVPE processes in which gaseous metal halides are used to epitaxially grow thick layers of compound nitride semiconductor materials on heated substrates. The HVPE chamber 602 comprises a chamber body 614 where a substrate is placed to undergo processing, a chemical delivery module 618 from which gas precursors are delivered to the chamber body 614, and an electrical module 622 that includes the electrical system for the HVPE chamber of the processing system 600.

Each MOCVD chamber 603a, 603b comprises a chamber body 612a, 612b forming a processing region where a substrate is placed to undergo processing, a chemical delivery module 616a, 616b from which gases such as precursors, purge gases, and cleaning gases are delivered to the chamber body 612a, 612b and an electrical module 620a, 620b for each MOCVD chamber 603a, 603b that includes the electrical system for each MOCVD chamber of the processing system 600. Each MOCVD chamber 603a, 603b is adapted to perform CVD processes in which metalorganic elements react with metal hydride elements to form thin layers of compound nitride semiconductor materials.

The processing system 600 comprises a transfer chamber 606 housing a robot assembly 607, an HVPE chamber 602, a first MOCVD chamber 603a, and a second MOCVD chamber 603b coupled with the transfer chamber 606, a loadlock chamber 608 coupled with the transfer chamber 606, a batch loadlock chamber 609, for storing substrates, coupled with the transfer chamber 606, and a load station 610, for loading substrates, coupled with the loadlock chamber 608. The transfer chamber 606 comprises a robot assembly 620 operable to pick up and transfer substrates between the loadlock chamber 608, the batch loadlock chamber 609, the HVPE chamber 602, the first MOCVD chamber 603a, and the second MOCVD chamber 603b.

The transfer chamber 606 may remain under vacuum and/or at a pressure below atmosphere during the process. The vacuum level of the transfer chamber 606 may be adjusted to match the vacuum level of corresponding processing chambers. For example, when transferring a substrate from a transfer chamber 606 into the HVPE chamber 602 (or vice versa), the transfer chamber 606 and the HVPE chamber 602 may be maintained at the same vacuum level. Then, when transferring a substrate from the transfer chamber 606 to the load lock chamber 608 or batch load lock chamber 609 (or vice versa), the transfer chamber vacuum level may match the vacuum level of the loadlock chamber 608 or batch load lock chamber 609 even through the vacuum level of the loadlock chamber 608 or batch load lock chamber 609 and the HVPE chamber 602 may be different. Thus, the vacuum level of the transfer chamber may be adjusted. In certain embodiments it may be desirable to backfill the transfer chamber 606 with an inert gas such as nitrogen. In one embodiment, the substrate is transferred in an environment having greater than 90% N₂. In certain embodiments, the substrate is transferred in a high purity NH₃ environment. In one embodiment, the substrate is transferred in an environment having greater than 90% NH₃. In certain embodiments, the substrate is transferred in a high purity H₂ environment. In one embodiment, the substrate is transferred in an environment having greater than 90% H₂.

In the processing system 600, the robot assembly transfers a carrier plate 611 under vacuum loaded with substrates into the HVPE chamber 602 to undergo a first deposition process. The carrier plate 611 size may range from 200 mm-750 mm. The carrier plate 611 may be formed from a variety of materials, including SiC or SiC-coated graphite. The robot assembly transfers the carrier plate 611 under vacuum into the first MOCVD chamber 603a to undergo a second deposition process. The robot assembly transfers the carrier plate 611 under vacuum into the second MOCVD chamber 603b to undergo a third deposition process. After all or some of the deposition steps have been completed, the carrier plate 611 is transferred from either the HVPE chamber 602 or one of the MOCVD chambers 603a, 603b back to the loadlock chamber 608. In one embodiment, the carrier plate 611 is then released toward the load station 610. In another embodiment, the carrier plate 611 may be stored in either the loadlock chamber 608 or the batch load lock chamber 609 prior to further processing in the HVPE chamber 602 or MOCVD chambers 603a, 603b. One exemplary system is described in U.S. patent application Ser. No. 12/023,572, filed Jan. 31, 2008, now published as US 2009-0194026, titled PROCESSING SYSTEM FOR FABRICATING COMPOUND NITRIDE SEMICONDUCTOR DEVICES, which is hereby incorporated by reference in its entirety.

A system controller 660 controls activities and operating parameters of the processing system 600. The system controller 660 includes a computer processor and a computer-readable memory coupled to the processor. The processor executes system control software, such as a computer program stored in memory. Aspects of the processing system and methods of use are further described in U.S. patent application Ser. No. 11/404,516, filed Apr. 14, 2006, now published as US 2007-0240631, titled EPITAXIAL GROWTH OF COMPOUND NITRIDE STRUCTURES, which is hereby incorporated by reference in its entirety.

In one embodiment, the processing system 600 comprises one HVPE chamber 602 and two MOCVD chambers 603a and 603b. Such a processing system may be used to fabricate a device according to the methods described herein. A patterned sapphire substrate may be provided to the processing system through the loadlock chamber 608 or the batch loadlock chamber 609 on the substrate carrier 611, and disposed in the HVPE chamber 602 by the robot assembly 607. A multi-step HVPE process may be performed in the HVPE chamber to deposit a buffer layer, such as an AlN layer, followed by one or more GaN layers, which may be doped or undoped, according to any of the methods disclosed above. The substrate may then be moved to one of the MOCVD chambers for formation of the active MQW layer, then back to the HVPE chamber for formation of the second GaN layer or plurality of doped and undoped GaN layers. The substrate may then be disposed in the loadlock chamber 608 or the batch loadlock chamber 609 to exit the system 600.

In an alternate embodiment, the additional chamber 604 of the system 600 may be a second HVPE chamber, which may be used to form the second GaN layer or plurality of layers following formation of the active MQW layer, or the second HVPE layer may be used to form the first GaN layer or plurality of doped and undoped GaN layers following formation of the AlN buffer layer on a silicon-containing substrate, as well as forming the second GaN layer or plurality of doped and undoped GaN layers following formation of the MQW active layer.

While the foregoing is directed to embodiments of the invention, other and further embodiments of the invention may be devised without departing from the basic scope thereof.

1. A method of depositing a film on a substrate, comprising:
exposing a first group III metal to a first hydrogen-free halogen containing gas to form a first precursor;
forming a first film on a substrate by reacting the first precursor with a first nitrogen source;
exposing a second group III metal to a second hydrogen-free halogen containing gas to form a second precursor; and
forming a second film on the substrate by reacting the second precursor with a second nitrogen source.

2. The method of claim 1, wherein each of the first and second group III metals comprises aluminum, gallium or indium.

3. The method of claim 1, wherein the first and second hydrogen-free halogen containing gases are each selected from the group consisting of F₂, Cl₂, Br₂, I₂, combinations thereof, and mixtures thereof.

4. The method of claim 1, wherein the first and second hydrogen-free halogen containing gases are each Cl₂.

5. The method of claim 1, wherein the first and second nitrogen sources are each ammonia or an active nitrogen source formed from a remote plasma.

6. The method of claim 1, wherein forming the first and second films are each performed in one process chamber.

7. The method of claim 1, wherein the substrate comprises a material selected from the group consisting of silicon, silicon carbide, and sapphire, a mixture thereof, a combination thereof, and an alloy thereof.

8. A method of forming a support surface for electronic devices, comprising:
forming a foundation surface comprising a nitrogen containing film on a structural substrate by exposing the structural substrate to a nitrogen containing gas;
contacting a first hydrogen-free halogen containing gas with a first metal to form a first precursor;
depositing a first layer adjacent to the foundation surface by reacting the first precursor with a first reagent;
contacting a second hydrogen-free halogen containing gas with a second metal to form a second precursor; and
depositing a second layer adjacent to the first layer by reacting the second precursor with a second reagent to form the support surface.

9. The method of claim 8, wherein depositing the first and second layers are performed in different process chambers, and the first layer comprises aluminum nitride that is disposed over a surface of the structural substrate which comprises silicon.

10. The method of claim 8, wherein the first and second hydrogen-free halogen containing gases are each selected from the group consisting of chlorine gas, bromine gas, iodine gas, combinations thereof, and mixtures thereof.

11. The method of claim 8, wherein the first and second hydrogen-free halogen containing gases are each chlorine gas.

12. The method of claim 11, wherein the first metal is solid aluminum and the second metal is liquid gallium.

13. The method of claim 11, wherein the first and second reagents are each ammonia.

14. The method of claim 8, further comprising ramping a temperature of the structural substrate to a first target temperature while exposing the structural substrate to the nitrogen containing gas.

15. The method of claim 14, wherein the nitrogen containing gas is ammonia.

16. The method of claim 8, wherein the structural substrate comprises a material selected from the group consisting of Si, SiC, LiAlO₂, LiGaO₂, ZnO, Al₂O₃, sapphire, a mixture thereof, a combination thereof, or an alloy thereof.

17. A method of treating a substrate, comprising:
exposing a first metal to a first hydrogen-free halogen containing gas to form a first halogen containing precursor;
exposing a second metal to a second hydrogen-free halogen containing gas to form a second halogen containing precursor; and
reacting the first and second halogen containing precursors with a nitrogen source in a volumetric ratio selected to deposit a first layer comprising desired amounts of the first and second metals on the substrate.

18. The method of claim 17, wherein the first and second hydrogen-free halogen containing gases are each fluorine gas, chlorine gas, bromine gas, iodine gas, a combination thereof, or a mixture thereof.

19. The method of claim 17, wherein the substrate comprises a material selected from the group consisting of Al₂O₃, Si, SiC, LiAlO₂, LiGaO₂, ZnO, sapphire, a mixture thereof, a combination thereof, or an alloy thereof.

20. The method of claim 17, further comprising varying the volumetric ratio to form a concentration gradient of the first and second metals in the first layer.

21. The method of claim 20, further comprising stopping flow of the first halogen containing precursor and depositing a second layer comprising the second metal on the substrate.

22. The method of claim 17, wherein the first and second metals comprise aluminum, gallium or indium.

23. A method of depositing a film on a substrate, comprising:
flowing a first hydrogen-free halogen containing gas across a first metal to form a first metal halide precursor;
reacting the first metal halide precursor with a first nitrogen source to deposit a plurality of discrete nucleation sites on the substrate, each nucleation site comprising the first metal;
flowing a second hydrogen-free halogen containing gas across a second metal to form a second metal halide precursor; and
reacting the second metal halide precursor with a second nitrogen source to deposit a film comprising the second metal on the substrate.

24. The method of claim 23, wherein the first and second hydrogen-free halogen containing gases are each selected from the group containing fluorine gas, chlorine gas, bromine gas, iodine gas, mixtures thereof, and combinations thereof.

25. The method of claim 24, wherein the first and second metals are each selected from the group consisting of aluminum, gallium, indium, mixtures thereof, combinations thereof, and alloys thereof.

26. The method of claim 25, wherein the substrate comprises a material selected from the group consisting of sapphire, Al₂O₃, Si, SiC, LiAlO₂, LiGaO₂, ZnO, mixtures thereof, combinations thereof, and alloys thereof.

27. The method of claim 26, wherein the first and second nitrogen sources are each selected from the group consisting of ammonia, active nitrogen species formed from a remote plasma, combinations thereof, and mixtures thereof.
